(19) United States
(12) Patent Application Publication
(10) Pub. No.: US 2026/0196226 A1
(43) Pub. Date: Jul. 9, 2026

(54) Receiver for Decoding an Audio Signal including a kind of switching means and Corresponding Method

(71) Applicant: Fraunhofer-Gesellschaft zur Förderung der angewandten Forschung e.V., München (DE)

(72) Inventors: Nicola PIA, Erlangen (DE); Andreas BRENDEL, Erlangen (DE); Guillaume FUCHS, Erlangen (DE); Kishan GUPTA, Erlangen (DE); Suraj PANDEY, Erlangen (DE); Markus MULTRUS, Erlangen (DE)

(73) Assignee: Fraunhofer-Gesellschaft zur Förderung der angewandten Forschung e.V., München (DE)

(21) Appl. No.: 19/553,210

(22) Filed: Feb. 28, 2026

Related U.S. Application Data
(63) Continuation of application No. PCT/EP2024/074222, filed on Aug. 29, 2024.

(30) Foreign Application Priority Data
Aug. 29, 2023 (EP) 23193958.8

(51) Int. Cl. G10L 19/008; G10L 25/30

(52) U.S. Cl. CPC G10L 19/008; G10L 25/30

(57) ABSTRACT

A receiver for decoding an encoded audio signal, the receiver having: a decoder configured to receive the encoded audio signal, the encoded audio signal including a mix of a plurality of audio signals, and apply a learnable model to decode the encoded audio signal for obtaining an audio output signal, wherein the learnable model is configured to decode the encoded audio signal such that the audio output signal includes only one of the plurality of audio signals and such that the audio output signal includes some or all of the plurality of audio signals; wherein the learnable model is configured to decode responsive to a control signal being integral part of the decoder either audio signal such that the audio output signal includes only one of the plurality of audio signals or such that the audio output signal includes some or all of the plurality of audio signals.

### CROSS-REFERENCE TO RELATED APPLICATIONS

This application is a continuation of copending International Application No. PCT/EP 2024/074222, filed Aug. 29, 2024, which is incorporated herein by reference in its entirety, and additionally claims priority from European Application No. 23193958.8, filed Aug. 29, 2023, which is also incorporated herein by reference in its entirety.

### TECHNICAL FIELD

Embodiments of the present invention refer to a receiver for decoding an audio signal and to a corresponding method. Advantageous embodiments refer to a receiver for decoding an audio signal having a “switch” or switching means at the receiver or decoder side. In general, embodiments of the present invention are in the field of joint neural coding and source separation with control signal at decoder side.

### BACKGROUND OF THE INVENTION

The most recent advances in neural speech coding [1], [2], [3], demonstrate the power of end-2-end neural network methods for wideband speech coding at bit rates as low as 3.0 kbps. These works test the performance of such methods on both clean and noisy speech, showing their robustness in many different scenarios.

For example, some neural coders or in general, trainable coders have a capability to separate between noisy and clean speech (so called joint speech coding and enhancement). For such coding methods, the decision for sending either the clean or the noisy signal is made or has to be made on transmitter side, i.e., the transmitter encodes and transmits the noisy signal or performs speech enhancement prior to transmission and transmits the encoded cleaned signal. Therefore there is a need for an improved approach.

It is an objective of the present invention to provide a concept for efficiently encoding and decoding a mixture (e.g. signal_1+signal_2+ . . . , like clean and a noisy speech).

### SUMMARY

According to an embodiment, a receiver for decoding an encoded audio signal may have: a decoder configured to receive the encoded audio signal, the encoded audio signal including a mix of a plurality of audio signals, and apply a learnable model to decode the encoded audio signal for obtaining an audio output signal, wherein the learnable model is configured to decode the encoded audio signal to obtain the audio output signal including some or all of the plurality of audio signals; wherein the learnable model is configured to decode responsive to a control signal being integral part of the receiver either to obtain the audio output signal including only one of the plurality of audio signals or to obtain the audio output signal including some or all of the plurality of audio signals; wherein the learnable model has a neural codec model or neural decoding model or wherein the learnable model is a neural speech codec model having NESC codec or learned codec based on the TADE styling layer.

According to another embodiment, a method for decoding an encoded audio signal may have the steps of: receiving the encoded audio signal, the encoded audio signal including a mix of a plurality of audio signals, and applying a learnable model to decode the encoded audio signal for obtaining an audio output signal, wherein the learnable model is configured to decode the encoded audio signal to obtain the audio output signal including only one of the plurality of audio signals and to obtain audio output signal including some or all of the plurality of audio signals; wherein the learnable model is configured to decode responsive to a control signal being integral part of the decoder either to obtain the audio output signal including only one of the plurality of audio signals or to obtain the audio output signal including some or all of the plurality of audio signals; wherein the learnable model has a neural codec model or neural decoding model or wherein the learnable model is a neural speech codec model having NESC codec or learned codec based on the TADE styling layer.

Another embodiment may have a non-transitory digital storage medium having stored thereon a computer program for performing the method for decoding an encoded audio signal according to the invention as mentioned above when the computer program is run by a computer.

Embodiments of the present invention provide a receiver for decoding an encoded audio signal comprising at least a decoder. The decoder is configured to receive the encoded audio signal which includes a mix of a plurality of audio signals, e.g., clean and noisy speech. The decoder is further configured to apply a learnable model, like a neural decoder to decode the encoded audio signal to obtain an audio output signal. The learnable model is configured to decode the encoded audio signal, such that the audio output signal includes only one of the plurality of audio signals and such that the audio output signal includes some or all of the plurality of audio signals. In response to a control signal being an integral part of the decoder, the decoder decodes/outputs the audio signal, such that the audio output signal includes only one of the plurality of audio signals or such that the audio output signal includes some or all of the plurality of audio signals. Expressed in other words this means that the decoder can at any time pick between decoding the mixture or just one of the signals. According to embodiments, the receiver provides the control signal preprocessed by the switch to the decoder either as input combined with the received bitstream or as a separate input. In other words, the control signal is independent from the encoder side and only given at the decoder side.

According to embodiments, the encoder sends both, the encodings of clean and noisy signal, in a single bitstream such that the receiver can decode either the clean or the noisy signal without further transmission overhead. This is not possible with existing trainable coders.

An embodiment provides a receiver, where the learnable model or neural codec model is configured to switch, responsive to the control signal, between a first decoding mode and a second decoding mode, and when operating in the first decoding mode, the audio output signal includes only one of a plurality of audio signals, and when operating in the second decoding mode, the audio output signal includes some or all of the plurality of audio signals. According to embodiments, the switch is configured to receive a control signal and translate it to a different representation to be provided to the decoder (so as to control same), i.e. to provide as response to the control signal a different representation to the decoder.

According to embodiments, the learnable model is a neural speech codec model comprising Switch NESC in denoising or exact reproduction mode. or generic speech enhancement module (codec), which may be learning based or not.

According to embodiments the learnable decoder is configured to decode, responsive to the control signal the audio signal either working in a first mode or in a second mode. The first mode and the second mode may be taken out of the above mentioned group. For example, the first mode enables the decoder to decode the audio signal such that the audio output signal includes only one of the plurality of audio signals, wherein the second mode enables decoder to decode the audio signal such that the audio output signal includes some or all of the plurality of audio signals. For example, the decoder working in the second node may be the Switch_NESC decoder working in exact reproduction mode, wherein the decoder working in the first mode may be a Switch_NESC decoder working in denoising mode.

Embodiments of the present invention are based on the principle/novel approach to build a switch at the decoder side, which allows the end-user at the receiver side to decide whether to play back some or all of the plurality of audio signals or just one audio signal or to play back, for example, the noisy or the denoised version of the coded speech. This specific embodiment is concentrated on the case, where the mixture is noisy speech and the signal wanted to be separated is the clean speech, i.e., it is wanted to jointly code and enhance speech. The classical approach to such problems is to use a denoiser model either at encoder or decoder side or alternatively to jointly train encoder and decoder to enhance speech. However, just the approach where at the decoder side it can be decided by use of a switch or control signal enabled to use the better fitting codec for the current situation (input signal and/or user preference) is not covered by known technology. Consequently, embodiments of the present invention have the advantage, that at the decoder side alternative audio output signals can be generated, so that the user or the receiver can decide which of the generated audio output signals should be used. For example, the encoder outputs different versions, like a “noisy” and “clean” version in a single bitstream and then it can be decided at decoder side whether to reproduce the “noisy” speech or the “clean” version. Consequently, no extra module (an extra speech enhancement system) is needed at decoder side nor an extra bitstream has to be transmitted (including mixture and separated signals).

According to embodiments, the plurality of audio signals comprises audio signals from a plurality of different audio sources, e.g., from different speakers, from different locations, or comprises background noise or music, voice or a mix comprising at least one of the previous elements.

According to further embodiments, the learnable model is configured to decode the encoded audio signal such that the audio output signal include the audio signal from only one of the plurality of audio sources, or a mix of the audio signals from some or all of the plurality of audio sources.

According to embodiments, the plurality of audio signals comprise speech signals, and the learnable model/neural codec model is a neural speech codec model. For example, the mix of audio signals comprises a mix of speech signals from a plurality of different audio sources, like different speakers, or comprises background noise or music, voice or a mix comprising at least one of the previous elements; and

wherein the neural speech codec model is configured to decode the encoded audio signal such that the audio output signal includes the speech signal from only one of the plurality of audio sources, or a mix of the speech signals from some or all of the plurality of audio sources. Alternatively, the mix of audio signals comprises a mix of a clean speech signal and a noise signal, like background noise, and
wherein the neural speech codec model is configured to decode the encoded audio signal such that the audio output signal includes only the clean speech signal, or a noisy speech signal including a mix of the clean speech signal and the noise signal.

According to embodiments, the decoder is configured to receive the control signal from an application, like a speech recognition application, or from a user, like a person listening to the audio signal, or to generate the control signal automatically. Note, pseudo code may describe the model for one specific use case. For example, dependent on SNR estimation the control signal may be generated automatically.

Another embodiment provides a method for decoding an encoded audio signal with the central steps
receiving the encoded audio signal, the encoded audio signal (e.g. the bitstream) including a mix of a plurality of audio signals, and
applying a learnable model to decode the encoded audio signal for obtaining an audio output signal (to be output by a receiver).

Here, the learnable model is configured to decode the encoded audio signal such that the audio output signal includes only one of the plurality of audio signals and such that the audio output signal includes some or all of the plurality of audio signals, wherein the learnable model is configured to decode responsive to a control signal being integral part of the receiver either audio signal such that the audio output signal includes only one of the plurality of audio signals or such that the audio output signal includes some or all of the plurality of audio signals. The receiver preprocesses the CS by the switch and provides it to the decoder which is a part of the receiver. Note, the learnable model is configured to decode—responsive to a control signal being an integral part of the decoder—the audio signals, such that the audio output signal includes only one of the plurality of audio signals or such that the audio signal includes some or all of the plurality of audio signals.

According to embodiments, the method may be computer implemented, therefore another embodiment provides a computer program for performing the above described method.

### BRIEF DESCRIPTION OF THE DRAWINGS

Embodiments of the present invention will subsequently be discussed referring to the enclosed figures, in which:

FIG. 1 shows a schematic block diagram of a decoder according to a basic implementation;

FIG. 2 shows a schematic block diagram illustrating the general framework according to embodiments;

FIG. 3 shows a schematic block diagram illustrating noise reduction according to embodiments;

FIG. 4 shows a schematic block diagram illustrating signal-speaker quality improvement according to embodiments; and

FIG. 5 shows a schematic block diagram illustrating an enhancement to the decoder operating in at least three modes according to embodiments.

### DETAILED DESCRIPTION OF THE INVENTION

Below, embodiments of the present invention will subsequently be discussed referring to the enclosed figures, wherein identical reference numbers are provided to objects having identical or similar function, so that description thereof is interchangeable and mutually applicable.

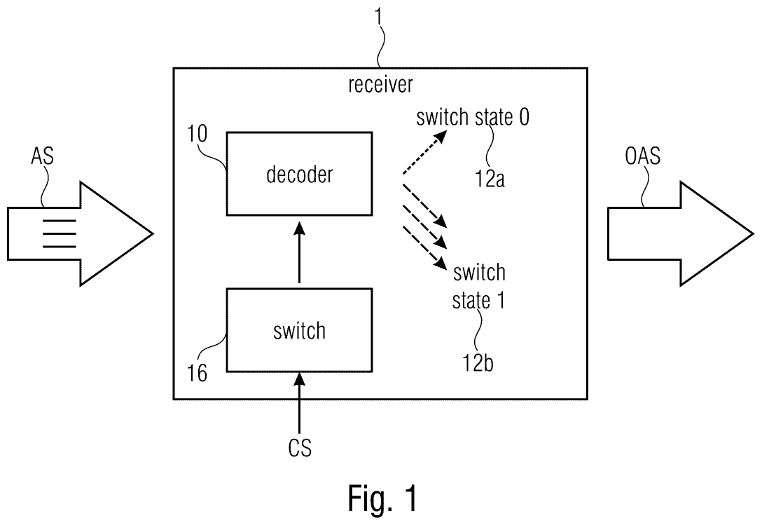

FIG. 1 shows a receiver 1 for decoding an encoded audio signal AS. The receiver 1 comprises a decoder 10 which is configured to apply a learnable model or neural codec model to provide an audio output signal OAS. For this the decoder 10 comprises a learnable model like a neural codec model. It is configured to use different decoding modes 12a and 12b, e.g. one where it (10) only outputs one signal in the mixture and one where it instead outputs the whole mixture. To sum up, the decoder may be a trained DNN that decodes a received bitstream and is controlled by a control signal CS via the switch 16.

Furthermore, the receiver 1 comprises a switch 16 which is configured to output/forward responsive to a control signal CS one signal decoded according to one of the modes 12a and 12b to the output or to switch between the different modes 12a and 12b. This means that the switch 16 can according to embodiments be arranged at the receiver 1 next to the decoder 10 so as to switch the decoder between the different modes 12a and 12b or can be arranged as integral part of the learnable model to switchably enable or use the different modes 12a and 12b. For example, the switch 16 receives a control signal CS from a user and configures the decoder 10 accordingly. CS evokes Mode m as working mode for the decoder, the OAS is the result of decoding in mode m. According to embodiments, the switch 16 may be a logic, e.g., for creating the control signal based on user input or other information available on receiver side.

The switch 16 of the receiver 1 receives a control signal at the receiver side. This means that the control signal is either generated by the decoder 10 itself or by the user using the decoder 10.

Note, that the bitstream (AS) is not explicitly composed of different components each encoding different signals or different signal mixtures, but the bitstream entangles the information of the individual signals which allows for transmitting the information related to all individual signals and signal mixtures at very low bit rates while maintaining the capability of reproducing each individual signal or mixtures thereof at the decoder side.

For example, as the different modes 12a and 12b Switch_NESC_with/without_denoise_3k2bps (Neural End-2-End Speech Codec (=robust, scalable end-to-end neural speech codec for high-quality wideband speech coding at 3 kbps) having the option to switch between use with denoising or use without denoising), may be used: the neural speech codec model is trained to be able to output both the clean and the noisy version of the input bit stream. This is enforced using a switch at the decoder side, so no extra bit rate is needed and the model can seamlessly switch between the two modes (noisy input→clean or noisy output).

According to embodiments the learnable model is a neural speech codec model comprising NESC codec and/or NESC codec having a switching function for switching between with or without denoise, also referred to as Switch NESC with/without denoise codec.

According to an embodiment, mode 12a outputs a plurality of audio signals, i.e. a mix of a plurality of audio signals (for example, a clean speech signal surrounded by background noise or music). This is illustrated by the plurality of arrows at the output side of the decoder 12. If the input signal is a noisy input signal, the output signal would be a noisy signal as well when using mode 12a. The second mode 12b may be a denoising mode. It enables in an end-to-end fashion to output the clean speech, even if inputted noisy speech. Thus, just one of the plurality of audio signals is output as OAS (cf. one arrow) at the output side of 12.

The switch 16 enables to switch between the two modes 12a and 12b. So, the decoder is configured to decode the encoded audio signal AS by use of the mode 12a and 12b, wherein the control signal allows to control the decoder 10, such that either the plurality of audio signals are output as OAS or just one audio signal is output as OAS. Therefore the main advantages of the concept as discussed in context of FIG. 1 are: the present invention offers the best trade-offs and flexibility to the user, by leaving the end receiver 1 the freedom to listen to the original background noise or effectively enhance it. This is a particular advantage in difficult conditions (e.g. when the receiver's background noise is loud), where intelligibility needs to be increased for a moment. It doesn't require an additional model or module for speech denoising, and therefore offers a potential advantage in terms of algorithmic and architectural complexity. Furthermore, there is no need for an extra bitstream for different signals or a dedicated structure within the bitstream for different signals.

As discussed above, the trainable/learnable model may be a neural codec model enabling to use different modes so as to output either one audio signal only (extraction of one audio signal out of a plurality of audio signals when decoding) or a plurality (all or some) of the plurality of input audio signals. Instead of the neural codec model like NESC other neural codecs which may operate in different modes depending on the state of the switch may be used as well. Note the codec or the generic speech enhancement module (codec) may be learning based or not.

As mentioned above, the switch 16 may be arranged at the receiver 1 or decoder side, this means that different modes are applied and a selection is done at the decoder. This principle will be discussed with respect to the below framework.

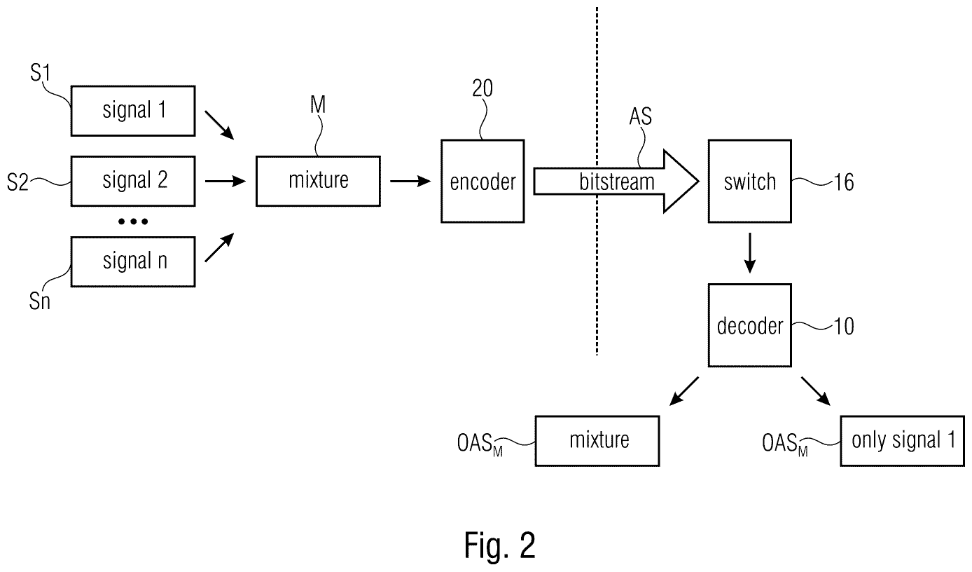

FIG. 2 shows the general framework for the embodiments. FIG. 2 illustrates on the left hand side marked by a reference numeral 20 the encoder and on the right hand side the decoder side 10. The encoder 20 receives a mixture M of different audio signals S1, S2, . . . , SN which are encoded by the encoder 20 so as to output a bitstream AS. This bit stream is referred to as encoded audio signal AS. The bit stream or the encoded audio signal AS is fed via the switch 16 to the decoder 10. The decoder 10 outputs the encoded audio signal AS in a

decoded manner either as output audio signal comprising a mixture OAS_{M} or as output audio signal comprising only one signal OAS1. This is dependent on the control signal for the switch 16.

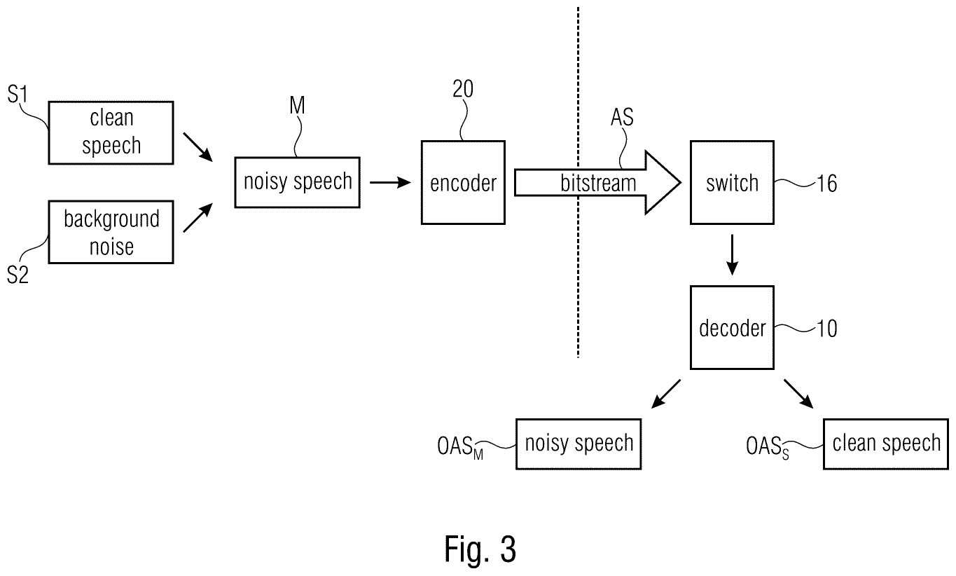

This approach has the main benefits, when one of the signals S1 to SN should be separated from the other. For example, the signal S1 may be clean speech while the signal S2 may be background noise. Consequently, the mixture M of the two signals S1 and S2 can be referred to as noisy speech. This mixture M can be a plurality of audio signals (2, 3 or more) provided by the encoder (see FIG. 3) which outputs the bit stream, also referred to as encoded audio signal AS to the decoder side. Based on the control signal CS provided to the switch 16 the decoder 10 can either output noisy speech (cf. OAS_{M}) or clean speech (OAS_{S}).

This framework illustrates a concept where the clean speech can be completely separated or not completely separated from the background noise.

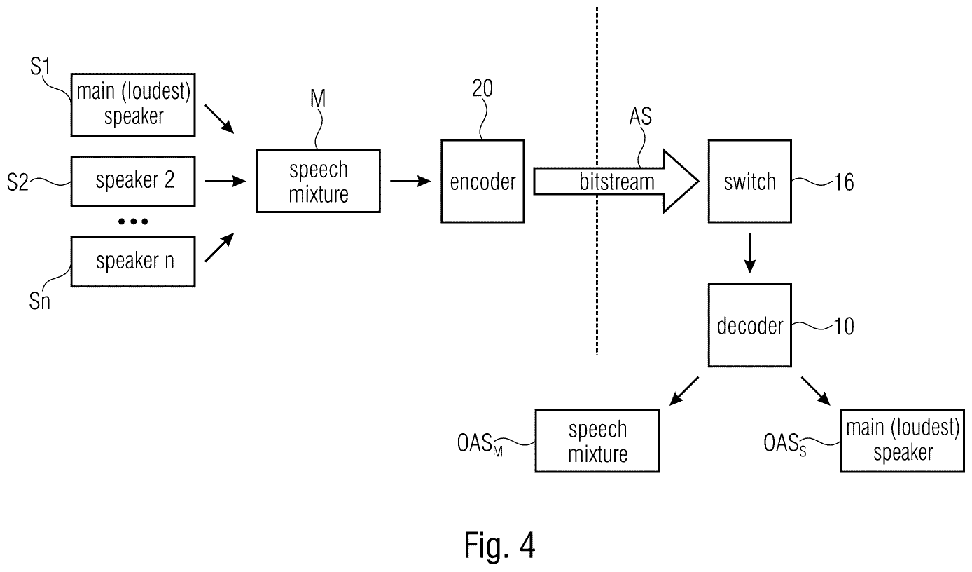

With respect to FIG. 4 another concept is discussed. According to the example of FIG. 4, the first signal S1 comprises the main (loudest) speaker or speech signal or mixture component, while the signals S2 or SN belong to different speakers, like speaker 2 or speaker N. All these channels are mixed together as speech mixture M. The speech mixture M is encoded in the encoder 20 so as to output the bit stream or encoded audio signal AS. By use of the decoder 10 and the switch 16 arranged at the decoder side the decoder or the use of the decoder can switch between outputting the speech mixture OAS_{M} or the main (loudest) speaker OASS, when just the one channel is selected by use of the control signal CS.

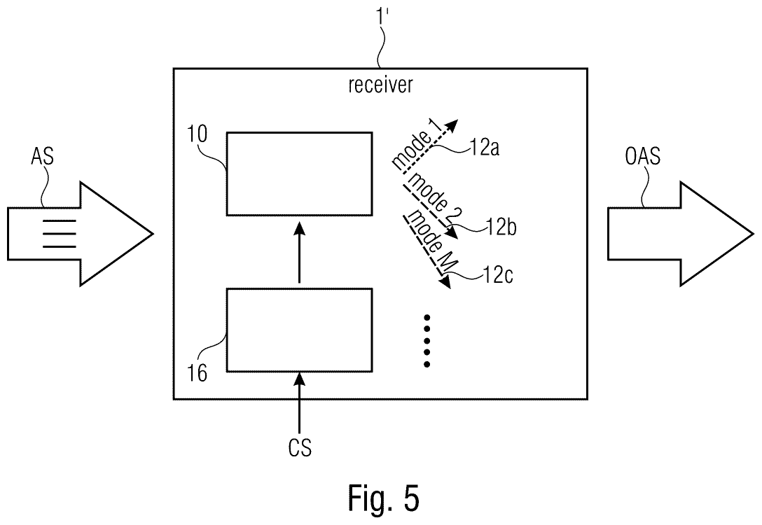

FIG. 5 shows a receiver 1′ according to another embodiment which is based on the embodiment of FIG. 1, but enhanced to enable to operate the decoder in three or M different modes 12a, 12b, 12c. The first mode may be used to reproduce a mix of a plurality of audio signals (for example, a clean speech signal surrounded by background noise or music), wherein the modes 12b and 12c enable to extract different target signals. For example, by use of the mode 12b a first target signal, like speech 1, can be reproduced while mode 12c enables the reproduction of a second target signal (another target signal), like speech 2. Alternatively, any subset of signals from the mixture (which would be the most generic version) can be extracted in the sense that if it works for 2 or three or M modes. For each mode or for each possible subset of signals to be extracted a dedicated switch position may be present. The switching between the different modes is performed by use of the switch 16 controlling the decoder in response to the control signal CS. CS evokes Mode m as working mode of the decoder, the OAS is the result of decoding in Mode m. It should be noted that the number of applicable modes can vary, i.e. exceed three (4, 5, 6, M). This means according to further embodiments, that the learnable model is additionally configured to decode the encoded audio signal (AS) according to one or more another modes so as to extract another target signal or another subset of signals from the mixture

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Pia, Nicola et al., “NESC: Robust Neural End-2-End Speech Coding with GANs”, https://arxiv.org/abs/2207.03282
[2] Zeghidour, Neil et al. “SoundStream: An End-to-End Neural Audio Codec”, https://arxiv.org/abs/2107.03312
[3] Défossez Alexandre et al., “High Fidelity Neural Audio Compression”, https://arxiv.org/abs/2210.13438
[4] Sebastian Braun et al., “Data augmentation and loss normalization for deep noise suppression”, https://arxiv.org/abs/2008.06412

1. A receiver for decoding an encoded audio signal, the receiver comprising:
a decoder configured to
receive the encoded audio signal, the encoded audio signal comprising a mix of a plurality of audio signals, and
apply a learnable model to decode the encoded audio signal for acquiring an audio output signal,
wherein the learnable model is configured to decode the encoded audio signal to acquire the audio output signal comprising some or all of the plurality of audio signals;
wherein the learnable model is configured to decode responsive to a control signal being integral part of the receiver either to acquire the audio output signal comprising only one of the plurality of audio signals or to acquire the audio output signal comprising some or all of the plurality of audio signals;
wherein the learnable model comprises a neural codec model or neural decoding model or wherein the learnable model is a neural speech codec model comprising NESC codec or learned codec based on the TADE styling layer.

2. The receiver of claim 1, wherein the control signal is provided oat the decoder side or generated at the decoder side.

3. The receiver of claim 1, wherein the learnable model is configured to switch, responsive to the control signal, between a first decoding mode and a second decoding mode, and
when operating in the first decoding mode, the audio output signal comprises only one of the plurality of audio signals, and
when operating in the second decoding mode, the audio output signal comprises some or all of the plurality of audio signals.

4. The receiver of claim 1,
wherein the learnable model is configured to decode responsive to a control signal the audio signal either with a first mode or a second mode, wherein the first mode enables to decode the audio signal to acquire the audio output signal comprising only one of the plurality of audio signals and wherein the second mode enables to decode the audio signal to acquire at the audio output signal comprising some or all of the plurality of audio signals.

5. The receiver of claim 1, wherein the plurality of audio signals comprises audio signals from a plurality of different audio sources, e.g., from different speakers, from different locations, or comprises background noise or music, voice or a mix comprising at least one of the previous elements.

6. The receiver of claim 5, wherein the learnable model is configured to decode the encoded audio signal to acquire the audio output signal comprising
the audio signal from only one of the plurality of audio sources, or
a mix of the audio signals from some or all of the plurality of audio sources.

7. The receiver of claim 1, wherein the plurality of audio signals comprises speech signals, and the learnable model is a neural speech codec model.

8. The receiver of claim 7, wherein the mix of audio signals comprises a mix of speech signals from a plurality of different audio sources, like different speakers, or comprises background noise or music, voice or a mix comprising at least one of the previous elements; and
wherein the neural speech codec model is configured to decode the encoded audio signal to acquire the audio output signal comprising
the speech signal from only one of the plurality of audio sources, or
a mix of the speech signals from some or all of the plurality of audio sources.

9. The receiver of claim 8, wherein the mix of audio signals comprises a mix of a clean speech signal and a noise signal, like background noise, and
wherein the neural speech codec model is configured to decode the encoded audio signal to acquire the audio output signal comprising
only the clean speech signal, or
a noisy speech signal comprising a mix of the clean speech signal and the noise signal.

10. The receiver of claim 1, wherein the decoder is configured to receive the control signal from an application, like a speech recognition application, or from a user, like a person listening to the audio signal, or to generate the control signal automatically; and/or
further comprising a switch configured to receive a control signal and to provide as response to the control signal a different representation of the control signal to the decoder.

11. The receiver of claim 1, wherein the learnable model is additionally configured to decode the encoded audio signal according to one or more another modes so as to extract a target signal or another subset of signals from the mixture;
wherein the learnable model is configured to decode responsive to the control signal either the encoded audio signal to acquire the audio output signal comprising only one of the plurality of audio signals or to acquire the audio output signal comprising some or all of the plurality of audio signals or to acquire the audio output signal comprising just the target signal.

12. A method for decoding an encoded audio signal, the method comprising:
receiving the encoded audio signal, the encoded audio signal comprising a mix of a plurality of audio signals, and
applying a learnable model to decode the encoded audio signal for acquiring an audio output signal,
wherein the learnable model is configured to decode the encoded audio signal to acquire the audio output signal comprising only one of the plurality of audio signals and to acquire audio output signal comprising some or all of the plurality of audio signals;
wherein the learnable model is configured to decode responsive to a control signal being integral part of the decoder either to acquire the audio output signal comprising only one of the plurality of audio signals or to acquire the audio output signal comprising some or all of the plurality of audio signals;
wherein the learnable model comprises a neural codec model or neural decoding model or wherein the learnable model is a neural speech codec model comprising NESC codec or learned codec based on the TADE styling layer.

13. A non-transitory digital storage medium having stored thereon a computer program
for performing a method for decoding an encoded audio signal, the method comprising:
receiving the encoded audio signal, the encoded audio signal comprising a mix of a plurality of audio signals, and
applying a learnable model to decode the encoded audio signal for acquiring an audio output signal,
wherein the learnable model is configured to decode the encoded audio signal to acquire the audio output signal comprising only one of the plurality of audio signals and to acquire audio output signal comprising some or all of the plurality of audio signals;
wherein the learnable model is configured to decode responsive to a control signal being integral part of the decoder either to acquire the audio output signal comprising only one of the plurality of audio signals or to acquire the audio output signal comprising some or all of the plurality of audio signals;
wherein the learnable model comprises a neural codec model or neural decoding model or wherein the learnable model is a neural speech codec model comprising NESC codec or learned codec based on the TADE styling layer,
when the computer program is run by a computer.
